(19) United States
(12) Patent Application Publication
(10) Pub. No.: US 2024/0399470 A1
(43) Pub. Date: Dec. 5, 2024

(54) TOOL HOLDER HAVING COUPLING HOLE AND LOCKING THROUGH BORE AND ROTARY CUTTING TOOL PROVIDED WITH TOOL HOLDER

(71) Applicant: ISCAR, LTD., TEFEN (IL)

(72) Inventor: SHIM’ON SHITRIT, KIBBUTZ METSUBA (IL)

(73) Assignee: ISCAR, LTD., TEFEN (IL)

(21) Appl. No.: 18/325,732

(22) Filed: May 30, 2023

(51) Int. Cl. B23B 51/00

(52) U.S. Cl. CPC B23B 51/0007

(57) ABSTRACT

A cutting head has driven surfaces and includes a head coupling pin that protrudes rearwardly from a head rear surface. The head coupling pin includes a pin recess recessed in the pin peripheral surface. A tool holder, elongated along a holder longitudinal axis, has driving members and a holder coupling hole recessed in a holder base surface. A fastening member is disposed in a holder through bore that extends from the holder base surface to a holder peripheral surface. The holder through bore is located entirely on one side of a longitudinal plane containing the holder longitudinal axis. When a cutting tool which includes the cutting head and tool holder is in a fastened position, the head coupling pin is removably retained within the holder coupling hole upon engagement with the fastening member.

### FIELD OF THE INVENTION

The subject matter of the present application relates to rotary cutting tools of the type in which a cutting head is releasably retained in a tool holder by means of a coupling mechanism.

### BACKGROUND OF THE INVENTION

Rotary cutting tools can be provided with a coupling mechanism for securely retaining a cutting head within a tool holder. The cutting head can include a male coupling member and the tool holder can include a female coupling member. At least one fastening member, in the form of a screw, can be used to releasably secure the male coupling member within the female coupling member, by engagement with a respective notch formed in the male coupling member.

Examples of such rotary cutting tools are disclosed in, for example, US 2005/098359 AA. US 2011/110739 AA. U.S. Pat. No. 5,649,794. KR200171644 Y1 and JP 3436110 B2.

### SUMMARY OF THE INVENTION

In accordance with a first aspect of the subject matter of the present application there is provided a tool holder, having a holder longitudinal axis, extending in a forward to rearward direction and about which the tool holder is rotatable in a rotational direction, the tool holder comprising:
a holder peripheral surface extending circumferentially about the holder longitudinal axis and forming a boundary of a holder base surface at a forward end of the tool holder;
two circumferentially spaced apart driving members extending forwardly from the holder base surface;
a holder coupling hole recessed in the holder base surface, the holder coupling hole comprising a coupling hole peripheral surface extending circumferentially about the holder longitudinal axis; and
a holder through bore comprising a bore peripheral surface extending circumferentially along a holder through bore axis and opening out to the coupling hole peripheral surface to form a through bore inner opening and the holder peripheral surface to form a through bore outer opening; and
a first holder longitudinal plane, extending parallel to the holder through bore axis and containing the holder longitudinal axis; wherein:
   the holder through bore is located entirely on one side of the first holder longitudinal plane.

In accordance with a second aspect of the subject matter of the present application there is provided a rotary cutting tool comprising:
a tool holder, of the type described above; and
a cutting head having a head central axis, the cutting head comprising a forward end forming a head cutting portion and a rearward end forming a head coupling portion;
the head cutting portion comprising:
   a head rear surface, defining a boundary between the head cutting portion and the head coupling portion;
   a head rear abutment surface, located on the head rear surface;
   two cutting arms extending radially with respect to the head central axis, each comprising a driven surface; and
the head coupling portion comprising a head coupling pin, protruding rearwardly from the head rear surface along the head central axis, the head coupling pin comprising:
   a pin rear surface spaced apart from the head rear surface and a pin peripheral surface extending therebetween;
   a pin recess, recessed in the pin peripheral surface, and comprising a pin recess surface comprising a pin abutment surface which slopes radially outwardly relative to the head central axis, in the rearward direction of the cutting head; and
   a fastening member releasably engaged to the tool holder at the holder through bore; wherein:
      the rotary cutting tool is adjustable between a free position and a fastened position, and in the fastened position:
         the cutting head is releasably attached to the tool holder by the fastening member;
         the head coupling pin is located in the holder coupling hole;
         each cutting arm is in contact with a respective driving member; and
         the fastening member protrudes into the holder coupling hole and abuts the pin abutment surface.

In accordance with another aspect of the subject matter of the present application there is provided a tool holder, having a holder longitudinal axis, extending in a forward to rearward direction and about which the tool holder is rotatable in a rotational direction, the tool holder comprising:
a holder peripheral surface extending circumferentially about the holder longitudinal axis and forming a boundary of a holder base surface at a forward end of the tool holder;
two circumferentially spaced apart driving members extending forwardly from the holder base surface;
a holder coupling hole recessed in the holder base surface, the holder coupling hole comprising a coupling hole peripheral surface extending circumferentially about the holder longitudinal axis; and
a holder through bore comprising a bore peripheral surface extending circumferentially along a holder through bore axis and opening out to the coupling hole peripheral surface to form a through bore inner opening and the holder peripheral surface to form a through bore outer opening; wherein:
the holder longitudinal axis is not visible from the holder peripheral surface through the holder through bore, in a view along the through bore axis.

It is understood that the above-said is a summary, and that features described hereinafter may be applicable in any combination to the subject matter of the present application, for example, any of the following features may be applicable to the tool holder or the rotary cutting tool:

The holder through bore can comprise a non-threaded bore engagement portion, the through bore inner opening being formed on the non-threaded bore engagement portion. The bore peripheral surface at the non-threaded bore engagement portion can lie on an imaginary bore cylinder having the holder through bore axis as its axis. In a cross-sectional view taken in a holder radial plane extending perpendicular to the holder longitudinal axis and intersecting the through bore inner opening, the imaginary bore cylinder can define parallel inner and outer bore straight lines, the inner bore line being closer to the first holder longitudinal plane than the outer bore line. Both the inner and outer bore lines can be located on the same side of the first holder longitudinal plane. At least the inner bore line of the inner and outer bore lines can intersect the coupling hole peripheral surface.

The holder through bore axis may not intersect the holder coupling hole.

Only the inner bore line of the inner and outer bore lines can intersect the coupling hole peripheral surface.

The first holder longitudinal plane and a tangent line oriented parallel to the holder through bore axis and tangentially touching the coupling hole peripheral surface can be spaced apart by a tangent distance. The first holder longitudinal plane and the inner bore line can be spaced apart by an inner line distance. The inner line distance can be greater than 75% of the tangent distance.

The inner bore line can intersect the coupling hole peripheral surface twice to define first and second intersection points, the first intersection point being rotationally ahead of the second intersection point. The first and second intersection points can subtend an intersection angle at the holder longitudinal axis. The intersection angle can be greater or equal to 45° and less than or equal to 75°.

The tool holder can have a second holder longitudinal plane extending perpendicular to the first holder longitudinal plane and containing the holder longitudinal axis. The first and second intersection points can be on opposite sides of the second holder longitudinal plane.

The tool holder can comprise exactly one holder through bore.

The tool holder can comprise a holder base abutment surface, located on the holder base surface. The holder base abutment surface can be planar and oriented perpendicular to the holder longitudinal axis.

The tool holder can comprise two holder flutes recessed in the holder peripheral surface and extending helically about the holder longitudinal axis. The holder coupling hole can open out to the two holder flutes.

The tool holder can further comprise a fastening member extending along a fastening member axis. The fastening member can comprise a fastening engagement portion and a fastening fixation portion located axially offset from the fastening engagement portion.

The fastening fixation portion can comprise a fastening external threaded portion. The fastening engagement portion can be non-threaded. The non-threaded fastening engagement portion can be longer than the fastening external threaded portion in a direction along the fastening member axis.

The holder through bore can comprise a bore fixation portion, for releasably attaching a fastening member thereto. The bore fixation portion can comprise a bore internal threaded portion.

The holder through bore can comprise a non-threaded bore engagement portion, the through bore inner opening being formed on the non-threaded bore engagement portion. The non-threaded bore engagement portion can be located axially opposite the bore internal threaded portion. The non-threaded bore engagement portion can comprise a through bore support surface located diametrically opposite the through bore inner opening about the through bore axis.

The holder through bore axis can lie in the holder radial plane.

In the fastened position of the rotary cutting tool, the fastening external threaded portion can be threadingly engaged with the bore internal threaded portion.

In the fastened position of the rotary cutting tool, the fastening engagement portion can simultaneously abut the pin abutment surface and the through bore support surface.

The fastening engagement portion can comprise a fastening engagement end surface and a fastening engagement peripheral surface that extends circumferentially along the fastening member axis and that circumferentially bounds the fastening engagement end surface. The fastening engagement portion can comprise a fastening abutment surface and a fastening peripheral bearing surface, the fastening peripheral bearing surface being located diametrically opposite the fastening abutment surface about the fastening member axis. In the fastened position of the rotary cutting tool, the fastening abutment surface can abut the pin abutment surface and the fastening peripheral bearing surface abuts the through bore support surface.

In the fastened position of the rotary cutting tool, the holder radial plane can intersect the pin abutment surface. In the cross-sectional view taken in the holder radial plane, the pin abutment surface can form an acute fastening surface angle with the through bore axis, the fastening surface angle can be greater or equal to 5° and less than or equal to 15°.

The pin recess surface can lie on an imaginary recess cylinder extending circumferentially along a recess cylinder axis oriented perpendicular to the head central axis, so that the pin abutment surface is concavely curved.

The tool holder can comprise a holder base abutment surface located on the holder base surface. In the fastened position of the rotary cutting tool, the head rear abutment surface can abut the holder base abutment surface.

The head coupling pin can comprise exactly one pin recess. The tool holder can comprise exactly one holder through bore and exactly one fastening member releasably engaged to the tool holder.

In the fastened position of the rotary cutting tool, the fastening member can abut the pin abutment surface at a contact region located on the same side of the second holder longitudinal plane as the first intersection point.

The pin peripheral surface can have a cylindrical shape having a pin diameter. The cutting head can have an outer cutting diameter. The pin diameter can be greater than a third of the outer cutting diameter.

### BRIEF DESCRIPTION OF THE FIGURES

For a better understanding of the present application and to show how the same may be carried out in practice, reference will now be made to the accompanying drawings, in which:

FIG. 1 is a perspective view of a rotary cutting tool in accordance with the present application;

FIG. 2 is an exploded perspective view of a forward end of the rotary cutting tool shown in FIG. 1;

FIG. 3 is a perspective view of a cutting head shown in FIGS. 1 and 2;

FIG. 4 is a side view of the cutting head shown in FIG. 3, along a recess cylindrical axis;

FIG. 5 is a rear view of the cutting head shown in FIG. 3;

FIG. 6 is a perspective view of a tool holder shown in FIGS. 1 and 2;

FIG. 7 is a cross-sectional view of the tool holder in FIG. 6, taken in a radial plane through a through bore inner opening along the line VII-VII;

FIG. 7A is a detail of FIG. 7;

FIG. 8 is a cross-sectional view of the tool holder in FIG. 6, taken in a plane parallel to a holder longitudinal axis and containing a through bore axis, along the line VIII-VIII in FIG. 7;

FIG. 9 is a cross-sectional view of the tool holder in FIG. 6, taken in a plane parallel to a holder longitudinal axis and perpendicular to the through bore axis, along the line IX-IX in FIG. 7;

FIG. 10 is a side view of the forward end of the rotary cutting tool, in a fastened position, shown in FIG. 1;

FIG. 11 is a cross-sectional view of the rotary cutting tool, taken along the line XI-XI in FIG. 10;

FIG. 11A is a detail of FIG. 11; and

FIG. 12 is a cross-sectional view of the rotary cutting tool, taken along the line XII-XII in FIG. 11.

It will be appreciated that for simplicity and clarity of illustration, elements shown in the figures have not necessarily been drawn to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following description, various aspects of the subject matter of the present application will be described. For purposes of explanation, specific configurations and details are set forth in sufficient detail to provide a thorough understanding of the subject matter of the present application. However, it will also be apparent to one skilled in the art that the subject matter of the present application can be practiced without the specific configurations and details presented herein.

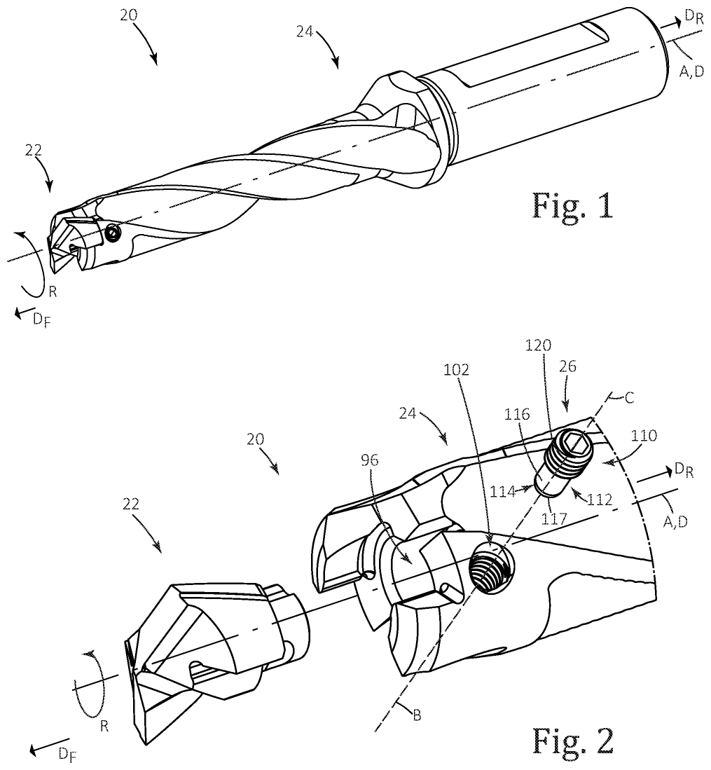

Attention is first drawn to FIGS. 1 and 2 showing a rotary cutting tool 20, of the type used for drilling operations, in accordance with embodiments of the subject matter of the present application. The rotary cutting tool 20 has a cutting head 22 which can be typically made from cemented carbide. The rotary cutting tool 20 also has a tool holder 24, complementary to the cutting head 22, which can be typically made from steel. The rotary cutting tool 20 is adjustable, at least, between a released and a fastened position. In the fastened position of the rotary cutting tool 20, the cutting head 22 is releasably attached in the tool holder 24, by a fastening member 26.

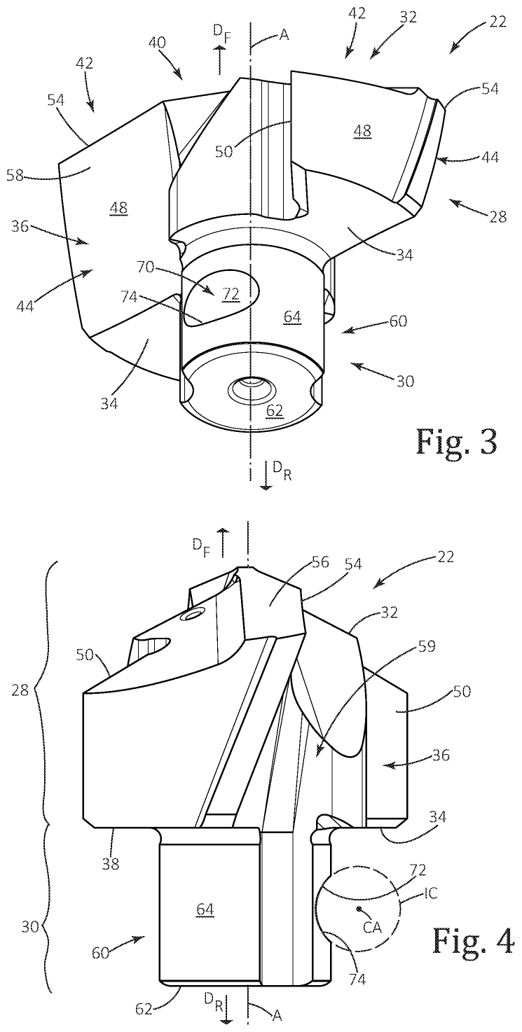

Reference is now made to FIGS. 3 to 5, showing the cutting head 22, in accordance with the subject matter of the present application. The cutting head 22 is made from a unitary integral one-piece construction (“monolithic construction”). The cutting head 22 has a head central axis A about which the cutting head 22 is rotatable in a rotational direction R. The rotational direction R is the cutting direction. In accordance with some embodiments of the subject matter of the present application the head central axis A can be a longitudinal axis. The head central axis A extends in forward to rearward directions D_{F}, D_{R}. As seen best in FIG. 4, the cutting head 22 includes a forward end that forms a head cutting portion 28 and a rearward end that forms a head coupling portion 30. It should be understood that use of the terms “forward” and “rearward” throughout the description and claims refer to a relative position in the direction of the head central axis A towards the up and down directions, respectively, in FIG. 4.

The head cutting portion 28 includes opposing head front and rear surface 32, 34 and a head peripheral surface 36 that extends between the head front and rear surfaces 32, 34. The head peripheral surface 36 extends circumferentially about the head central axis A. The head central axis A extends through the head front and rear surface 32, 34. The head rear surface 34 defines a boundary between the head cutting portion 28 and the head coupling portion 30. The head cutting portion 28 includes a head rear abutment surface 38 that faces generally in the rearward direction D_{R}, for abutting a complementary surface on the tool holder 24. The head rear abutment surface 38 is located on the head rear surface 34. In accordance with some embodiments of the subject matter of the present application, the head rear surface 34 can be planar and perpendicular to the head central axis A.

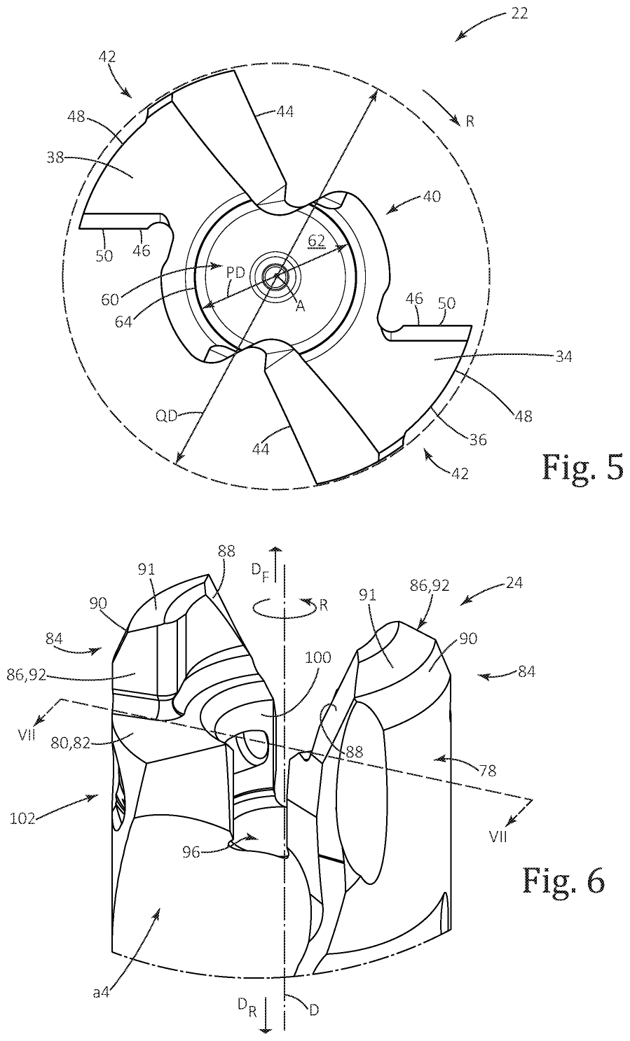

The head cutting portion 28 includes a head radially central portion 40. The head cutting portion 28 includes two cutting arms 42 that extend radially outwards, with respect to the head longitudinal axis A, from the head radially central portion 40. In this non-limiting example shown in the drawings, the head cutting portion 28 includes exactly two cutting arms 42, diametrically opposed to each other. Each cutting arm 42 respectively includes opposing arm rotationally leading and trailing surfaces 44, 46 and an arm peripheral surface 48 that extends peripherally between the arm rotationally leading and trailing surfaces 44, 46. The arm rotationally leading and trailing surfaces 44, 46 and the arm peripheral surface 48 are all located on the head peripheral surface 36. It should be understood that use of the terms “rotationally leading” and “rotationally trailing” throughout the description and claims refer to a position relative to the head rotational direction R. Each cutting arm 42 includes a driven surface 50 for driven engagement by a complementary surface on the tool holder 24. As seen in FIG. 5, in this non-limiting example, each driven surface 50 can be planar. Moreover, each driven surface 50 can be parallel to the head central axis A. In accordance with some embodiments of the subject matter of the present application, the driven surfaces 50 can be located on the arm rotationally trailing surfaces 46. Advantageously this allows for effective torque transfer to the cutting head via the driven surfaces 50. The driven surfaces 50 can be spaced apart from the head rear surface 34. Preferably, the driven surfaces 50 can be located axially forward of the head rear surface 34.

Each cutting arm 42 includes a respective major cutting edge 54. The major cutting edge 54 is formed along at least a portion of the intersection of the arm rotationally leading surface 44 and the head front surface 32. The head front surface 32 includes a plurality of major relief surfaces 56. Each major relief surface 56 extends from the respective major cutting edge 54 to which it is associated towards the opposite arm rotationally trailing surface 46 on the same cutting arm 42. Each arm rotationally leading surface 44 includes a respective major rake surface 58. Each major rake surface 58 extends from the major cutting edge 54 to which it is associated towards the head rear surface 34. As is known in the field of rotary cutting tools, each cutting arm 42 can include a cutting arm flute 59, associated with a respective major cutting edge 54, for the evacuation of chips.

The head coupling portion 30 includes a head coupling pin 60 that protrudes rearwardly from the head rear surface 34 along the head central axis A. The purpose of the head coupling pin 60 is to provide a coupling and centering means with the tool holder 24. The head coupling pin 60 includes a pin rear surface 62 that is spaced apart from the head rear surface 34 and a pin peripheral surface 64 which extends between the pin rear surface 62 and the head rear surface 34. In accordance with some embodiments of the subject matter of the present application the pin peripheral surface 64 can have a cylindrical shape having a pin diameter PD. As seen in FIG. 5, the pin diameter PD can be greater than a third of the outer cutting diameter OD of the cutting head 22. The head rear surface 34 can form a peripheral boundary of the pin peripheral surface 64 at the region where the head coupling pin 60 protrudes from the head rear surface 34.

As shown in, for example, U.S. Pat. No. 7,625,161, in accordance with some embodiments of the subject matter of the present application, portions of the head coupling pin 60 can form part of fluted sections (configured for chip evacuation) of the assembled rotary cutting tool 20. Thus, the head coupling pin 60 can be fluted.

The head coupling pin 60 includes a pin recess 70 for receiving a portion of fastening member 26. The pin recess 70 is recessed in the pin peripheral surface 64. The pin recess 70 includes a pin recess surface 72. Referring to FIG. 4, in accordance with some embodiments of the subject matter of the present application, as seen in a side view of the cutting head 22, the pin recess surface 72 can lie on an imaginary recess cylinder IC which extends circumferentially along a recess cylinder axis CA. The recess cylinder axis CA can be oriented perpendicular to (but not intersect) the head central axis A. The pin recess 70 can be spaced apart from the pin rear surface 62. The pin recess 70 can be spaced apart from the head rear surface 34.

The pin recess surface 72 includes a pin abutment surface 74, for engagement by the fastening member 26. The pin abutment surface 74 slopes radially outwardly relative to the head central axis A, in the rearward direction D_{R} of the cutting head 22. In accordance with some embodiments of the subject matter of the present application, the pin abutment surface 74 can be concavely curved. In particular, the pin abutment surface 74 can be formed on the lower half of the cylindrical pin recess surface 72.

Attention is drawn to FIGS. 6 to 9 showing the tool holder 24, in accordance with a first aspect of the subject matter of the present application. The tool holder 24 has a holder longitudinal axis D. In the fastened position of the rotary cutting tool 20, the tool holder 24 is co-axial with the cutting head 22 (i.e., the head central axis A and the holder longitudinal axis D are co-incident), and thus the holder longitudinal axis D can extend in the forward to rearward direction D_{F}, D_{R}. Moreover, the tool holder 24 is rotatable in the rotational direction R about the holder longitudinal axis D. The tool holder 24 includes a holder peripheral surface 78 that extends circumferentially about the holder longitudinal axis D. The holder peripheral surface 78 forms a boundary of a holder base surface 80 at a forward end of the tool holder 24. The tool holder 24 includes a holder base abutment surface 82 that faces generally in the forward direction D_{F}, for abutting a complementary surface on the cutting head 22. The holder base abutment surface 82 is located on the holder base surface 80. In accordance with some embodiments of the subject matter of the present application, the holder base surface 80 can be planar and perpendicular to the holder longitudinal axis D.

The tool holder 24 includes two circumferentially spaced apart driving members 84 that extend forwardly from the holder base surface 80. The driving members 84 serve to impart a drive torque TD to the cutting head 22 when the tool holder 24 rotates. In this non-limiting example shown in the drawings, the tool holder 24 includes exactly two driving members 84, diametrically opposed to each other. Each driving member 84 includes opposing driving member rotationally leading and trailing surfaces 86, 88 and a driving member peripheral surface 90 that extends peripherally between the driving member rotationally leading and trailing surfaces 86, 88. In accordance with some embodiments of the subject matter of the present application, each driving member 84 can include a respective driving member front surface 91 that axially delimits the driving member 84 in the forward direction D_{F}.

The driving member rotationally leading surface 86 includes a driving surface 92 for driven engagement with a respective complementary surface on the cutting head 22. In accordance with some embodiments of the subject matter of the present application, the driving surfaces 92 can be located axially forward of the holder base surface 80.

In accordance with some embodiments of the subject matter of the present application, the tool holder 24 can include two holder flutes 94 recessed in the holder peripheral surface 78. The two holder flutes 94 can extend helically about the holder longitudinal axis D. Each holder flute 94 extends in the forward direction D_{F} to the holder base surface 80 between the two respective driving members 84.

The tool holder 24 includes a holder coupling hole 96, for receipt of the head coupling pin 60 of the cutting head 22. The holder coupling hole 96 is recessed in the holder base surface 80 and extends along the holder longitudinal axis D in the rearward direction D_{R}. The holder coupling hole 96 includes a coupling hole rear surface 98 that is spaced apart from the holder base surface 80 and a coupling hole peripheral surface 100 that extends between the coupling hole rear surface 98 and the holder base surface 80 about the holder longitudinal axis D. In accordance with some embodiments of the subject matter of the present application the coupling hole peripheral surface 100 can have a cylindrical shape. The intersection of the coupling hole peripheral surface 100 and the holder base surface 80 can be beveled to allow easy initial insertion of the head coupling pin 60 when assembling the rotary cutting tool 20.

In accordance with some embodiments of the subject matter of the present application, the holder coupling hole 96 can open out to the two holder flutes 94, to allow a portion of the head coupling pin 60 to form part of fluted sections (configured for chip evacuation) of the assembled rotary cutting tool 20 (as described above).

The tool holder 24 includes a holder through bore 102 that extends along a holder through bore axis B from the holder coupling hole 96 to the holder peripheral surface 78. The holder through bore 102 includes a bore peripheral surface 104 which extends circumferentially along a holder through bore axis B. The bore peripheral surface 104 intersects (i.e., opens out to) the coupling hole peripheral surface 100 to form a through bore inner opening 107A. The through bore inner opening 107A extends across a circumferential extent of the coupling hole peripheral surface 100. The bore peripheral surface 104 also intersects the holder peripheral surface 78 to form a through bore outer opening 107B. It is noted that the holder through bore 102 is located rearwardly from the holder base surface 80, and thus is not formed on any part of the two driving members 84.

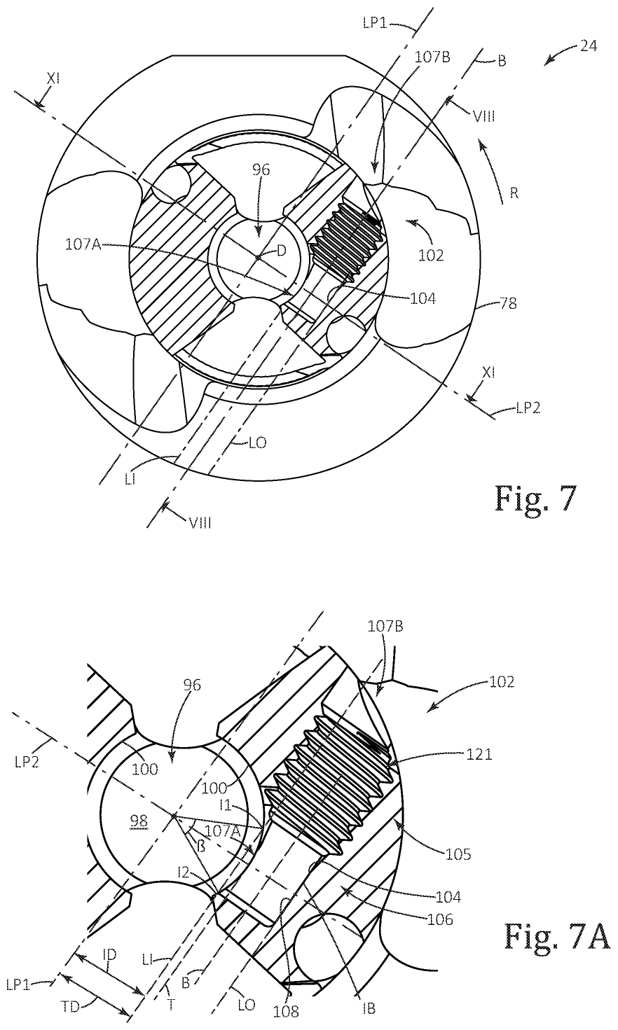

The tool holder 24 has a holder radial plane RP which is oriented perpendicular to the holder longitudinal axis D. The holder radial plane RP intersects the through bore inner opening 107A (and thus the holder coupling hole 96 and the holder through bore 102). Referring to FIG. 7, the tool holder 24 also has a first holder longitudinal plane LP1 which extends parallel to the holder through bore axis B and which contains the holder longitudinal axis D. Finally, the tool holder 24 has a second holder longitudinal plane LP2 which extends perpendicular to the first holder longitudinal plane LP1 and which also contains the holder longitudinal axis D. It should be understood that a radial plane is one perpendicular to a member's central axis, and a longitudinal plane is one containing the member's central axis.

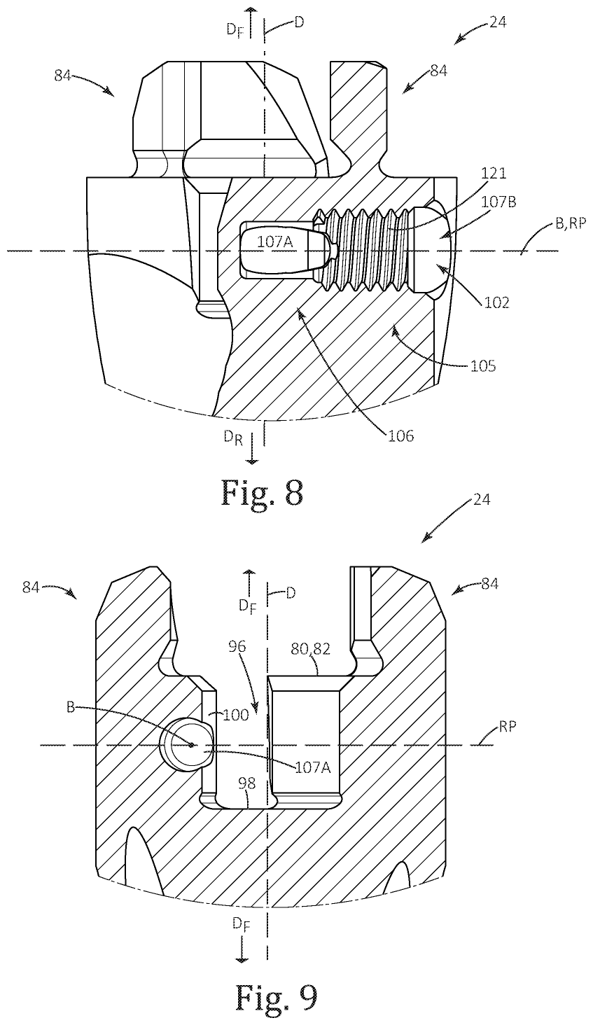

In accordance with some embodiments of the subject matter of the present application, as seen in FIGS. 8 and 9, the holder through bore axis B can lie in the holder radial plane RP. The holder through bore 102 can include a bore fixation portion 105, for releasably attaching the fastening member 26 thereto. In this non-limiting example, the bore fixation portion 105 is adjacent the holder peripheral surface 78. The bore fixation portion 105 can include a bore internal threaded portion 121.

The holder through bore 102 can include a non-threaded bore engagement portion 106 located axially opposite the bore internal threaded portion 121. The non-threaded bore engagement portion 106 is located inward of the bore internal threaded portion 121 along the through bore axis B from the through bore outer opening 107B. The non-threaded bore engagement portion 106 can include a through bore support surface 108 for supporting the fastening engagement portion 112 as described later in the description. The through bore inner opening 107A can be formed on the non-threaded bore engagement portion 106 and be located diametrically opposite the through bore support surface 108 about the through bore axis B.

In accordance with some embodiments of the subject matter of the present application, the bore peripheral surface 104 at the non-threaded bore engagement portion 106 can lie on an imaginary bore cylinder IB having the holder through bore axis B as its axis. Referring to FIG. 7A, in a cross-sectional view taken in the holder radial plane RP, the imaginary bore cylinder IB can define parallel inner and outer bore straight lines LI, LO. The inner bore line LI is closer to the first holder longitudinal plane LP1 than the outer bore line LO. It is noted that the inner and outer bore lines LI, LO are parallel the through bore axis B (and thus also the first holder longitudinal plane LP1).

The holder through bore 102 is located entirely on one side of the first holder longitudinal plane LP1. Thus, as best seen in FIG. 7A, in the cross-sectional view taken in the holder radial plane RP, both the inner and outer bore lines LI, LO are located on the same side of the first holder longitudinal plane LP1. As such, the holder axis D does not pass through an imaginary extension of the bore cylinder IB. Also, the holder axis D is not visible from the holder peripheral surface 78 through the holder through bore 102, in a view along the bore axis B.

At least the inner bore line LI of the inner and outer bore lines LI, LO intersects the coupling hole peripheral surface 100. In accordance with some embodiments of the subject matter of the present application, only the inner bore line LI of the inner and outer bore lines LI, LO intersects the coupling hole peripheral surface 100. That is to say, the outer bore line LO does not intersect the coupling hole peripheral surface 100. Preferably, the holder through bore axis B also may not intersect the holder coupling hole 96.

In accordance with some embodiments of the subject matter of the present application, in the cross-sectional view taken in the holder radial plane RP, the inner bore line LI can intersect the coupling hole peripheral surface 100 twice to define first and second intersection points I1, I2, where the first intersection point I1 is rotationally ahead of the second intersection point I2. The first and second intersection points I1, I2 can subtend an intersection angle β at the holder longitudinal axis D. The intersection angle β can be greater or equal to 45° and less than or equal to 75°. The first and second intersection points I1, I2 can be on opposite sides of the second holder longitudinal plane LP2.

As shown in FIG. 7A, in accordance with some embodiments of the subject matter of the present application, in the cross-sectional view taken in the holder radial plane RP, the first holder longitudinal plane LP1 and a tangent line T oriented parallel to the holder through bore axis B and tangentially touching coupling hole peripheral surface 100 can be spaced apart by a tangent distance TD. The first holder longitudinal plane LP1 and the inner bore line LI can be spaced apart by an inner line distance ID. The inner line distance ID can be greater than 75% of the tangent distance TD. Preferably, the inner line distance ID can be greater than 85% of the tangent distance TD.

Reverting to FIGS. 1 and 2, the tool holder 24 includes the fastening member 26, which may be a threaded screw, for engagement with the pin abutment surface 74 of the head coupling pin 60. The fastening member 26 is releasably engaged to the tool holder 24 at the holder through bore 102. The fastening member 26 extends along a fastening member axis C that is co-axial with the holder through bore axis B, in the fastened position of the cutting tool 20. In accordance with some embodiments of the subject matter of the present application, the fastening member 26 can include a fastening fixation portion 110 near its proximal end, and a fastening engagement portion 112 that is axially offset from the fastening fixation portion 110 closer to its distal (tip) end, along the fastening member axis C. The fastening member 26 can be headless (e.g., of the grub screw variety).

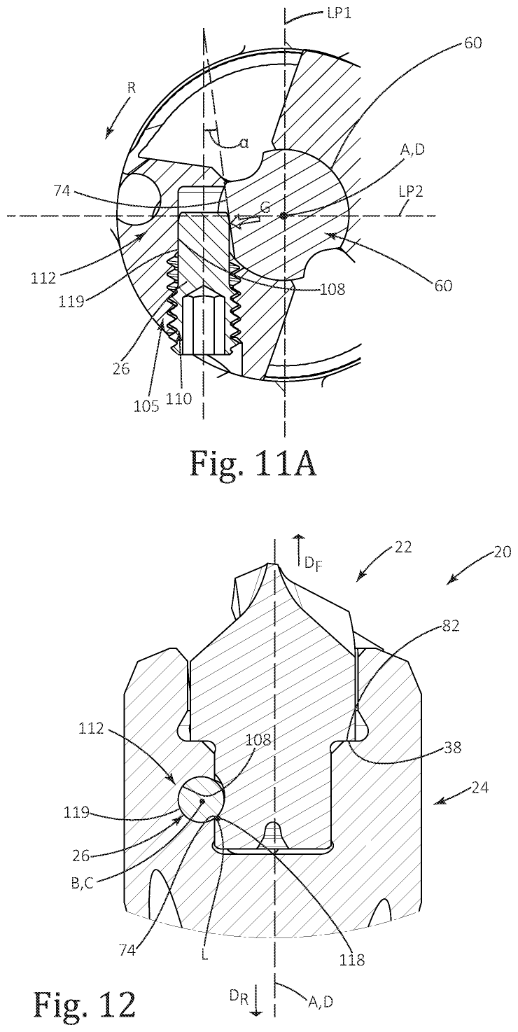

In accordance with some embodiments of the subject matter of the present application, the fastening fixation portion 110 can include a fastening external threaded portion 120. The fastening engagement portion 112 is non-threaded. The non-threaded fastening engagement portion 112 may be at least one-half the length of the fastening external threaded portion 120 in a direction along the fastening member axis C, as seen in FIG. 11. The non-threaded fastening engagement portion 112 can even be longer than the fastening external threaded portion 120 in a direction along the fastening member axis C (as seen in FIG. 11). The fastening engagement portion 112 can include a fastening engagement end surface 114 that is oriented perpendicular to the fastening member axis C and a fastening engagement peripheral surface 116 that extends circumferentially along the fastening member axis C and that circumferentially bounds the fastening engagement end surface 114. The fastening engagement peripheral surface 116 faces radially outwardly. The fastening engagement peripheral surface 116 can have a cylindrical shape. The end surface 114 and the peripheral surface 116 can intersect to form a fastening engagement tapered surface 117 which intersects the fastening engagement end surface 114. The fastening engagement tapered surface 117 can extend a full 360° about the fastening member axis C. The fastening engagement tapered surface 117 can have a decreasing taper angle in a direction towards the fastening fixation portion 110, so as to be convexly curved (in a side view of the fastening member 26). The fastening member axis C does not intersect the fastening engagement tapered surface 117.

The fastening engagement portion 112 can include a fastening abutment surface 118 for abutting the pin abutment surface 74. In particular, the fastening abutment surface 118 can be located on the fastening engagement tapered surface 117. The fastening engagement peripheral surface 116 can include a fastening peripheral bearing surface 119, for abutting the through bore support surface 108 (discussed later in the description). The fastening peripheral bearing surface 119 can be located diametrically opposite the fastening abutment surface 118 about the fastening member axis C. As such, the fastening peripheral bearing surface 119 may also be located on the fastening engagement tapered surface 117. It is thus understood that the fastening abutment surface 118 and the fastening peripheral bearing surface 119 are established only when the rotary cutting tool 20 is in the fastened position.

The fastening member 26 is releasably engaged to the tool holder 24 by the fastening fixation portion 110 engaging the bore fixation portion 105. In this non-limiting example, the fastening fixation portion 110 can include the fastening external threaded portion 120, and the bore fixation region 105 can include the bore internal threaded portion 121, and the fastening external threaded portion 120 is threadingly engaged with the bore internal threaded portion 121.

Yet another aspect of the subject matter of the present application includes the rotary cutting tool 20, having the tool holder 24 and the cutting head 22 releasably attached thereto by the fastening member 26. Referring now to FIGS. 1-2 and 10-12, the rotary cutting tool 20 is adjustable between a released position and a fastened position.

In the released position of the rotary cutting tool 20 the head coupling pin 60 is not located in the holder coupling hole 96. The cutting head 22 is not releasably attached in the tool holder 24.

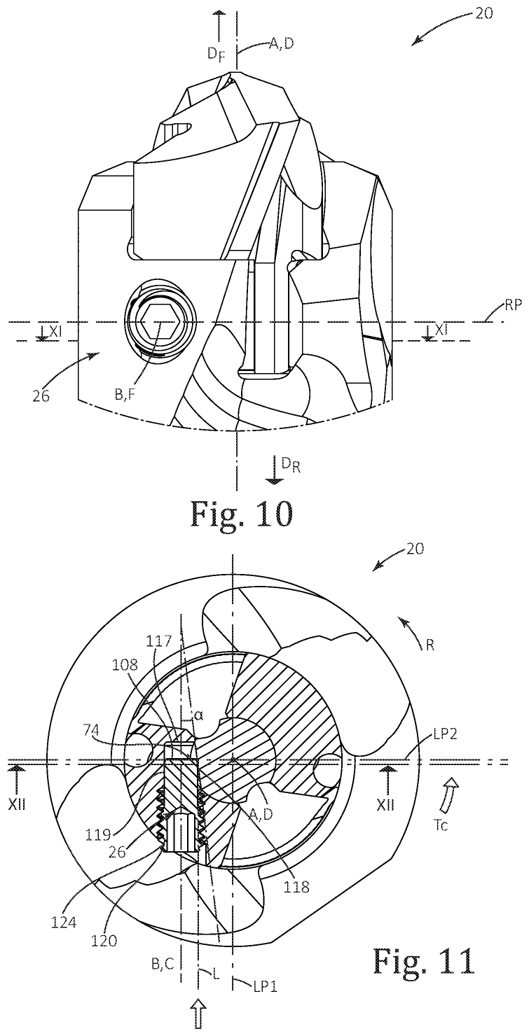

Referring now to FIGS. 10-12, in the fastened position of the rotary cutting tool 20, the cutting head 22 is releasably attached in the tool holder 24, by the fastening member 26. The head coupling pin 60 is located in the holder coupling hole 96. The head central axis A and the holder longitudinal axis D are co-axial. Each cutting arm 42 is in contact with a respective driving member 84. Specifically, each driven surface 50 abuts a respective driving surface 92. The fastening member 26 protrudes into the holder coupling hole 96 and abuts (i.e., clampingly engages) the pin abutment surface 74. The head rear abutment surface 38 abuts the holder base abutment surface 82.

In accordance with some embodiments of the subject matter of the present application, the head coupling pin 60 can include exactly one pin recess 70 (and in such a configuration the head coupling pin 30 may not be rotationally symmetrical about the head central axis A—i.e., have only 360° rotational symmetry).

Alternatively, the head coupling pin 60 can include exactly two pin recesses 70, diametrically opposed to each other about the head central axis A. Thus, engagement of the fastening member 26 with one of the two pin recesses 70 is guaranteed, regardless of the rotational position in which the head coupling pin 60 is initially inserted into the holder coupling hole 96.

The tool holder 24 can include exactly one holder through bore 102 and exactly one fastening member 26 releasably engaged to the tool holder 24. Thus, advantageously, only one fastening member is required to securely attach the cutting head 22 to the tool holder 24. For example, there is no requirement for an additional separate retaining screw for securely clamping the cutting head 22 to the tool holder 24, as disclosed in US 2011/110739. In this configuration, a portion of the pin peripheral surface 64 located diametrically opposite the pin abutment surface 74 abuts a portion of the coupling hole peripheral surface 100 located diametrically opposite the through bore inner opening 107A.

Assembly of the rotary cutting tool 20 is accomplished by performing the following steps. The head coupling pin 60 is positioned axially forward of, and facing towards, the holder coupling hole 96. It should be noted that in this position each cutting arm 42 is located axially forward and circumferentially between, each adjacent pair of driving members 84 (as best seen in FIG. 2). The cutting head 22 is then displaced rearwardly so that the head coupling pin 60 is initially inserted into the holder coupling hole 96. The cutting head 22 is then displaced further rearwardly until the head rear surface 34 initially comes into contact with the holder base surface 80.

The cutting head 22 is then rotated in a direction against the rotational direction R, relative to the tool holder 24, until each driven surface 50 initially abuts a respective driving surface 92. Next, the fastening member 26 is inserted into the holder through bore 102 (the fastening engagement portion 112 first), until it protrudes into the holder coupling hole 96 and initially comes into contact with the pin recess 70, specifically the pin abutment surface 74. The fastening member 26 exerts a fastening force F along a line of force L on the pin abutment surface 74. The line of force L is parallel to the fastening member axis C and the holder through bore axis B (but offset from the holder longitudinal axis D).

Referring to FIG. 11, the fastening engagement portion 112 of the fastening member 26 abuts the pin abutment surface 74 at a contact region which is located on one side of the first holder longitudinal plane LP1. Thus, the fastening force F urges the cutting head 22 to rotate in a direction against the rotational direction R, relative to the tool holder 24, until firm abutment is attained between the driven surfaces 50 and the driving surfaces 92. Advantageously, having the holder through bore 102 located entirely on one side of the first holder longitudinal plane LP1 ensures said contact region is sufficiently distanced from the first holder longitudinal plane LP1 (and thus from the holder longitudinal axis D) to reduce the fastening force F required to fasten the cutting head 22 to the tool holder 24. In accordance with some embodiments of the subject matter of the present application, the contact region can be located on the same side of the second holder longitudinal plane LP2 as where the fastening fixation portion 110 engages the bore fixation portion 105.

In accordance with some embodiments of the subject matter of the present application, in the cross-sectional view taken in the holder radial plane RP (e.g., FIGS. 11 and 11A), the pin abutment surface 74 can form a chord of a circle defined by the pin peripheral surface 60. In the fastened position, the holder radial plane RP intersects the fastening abutment surface 74, and the pin abutment surface 74 forms an acute fastening surface angle α with the through bore axis B. The acute fastening surface angle α can be shallow (i.e., greater or equal to 5° and less than or equal to 15°.

As best seen in FIG. 12, by virtue of the pin abutment surface 74 sloping radially outwardly relative to the head central axis A, in the rearward direction D_{R} of the cutting head 22, upon further insertion of the fastening member 26, the fastening force F urges the cutting head to be displaced in the rearward direction so that the head rear surface 34 firmly abuts the holder base surface 80.

In such a configuration described above, a fastened position of the rotary cutting tool 20 is formed. In the fastened position of the rotary cutting tool 20, the fastening member 26 clampingly engages the head coupling pin 60. Specifically, the fastening engagement portion 112 clampingly engages the head coupling pin's pin abutment surface 74. Further specifically, the fastening abutment surface 118, located on the fastening engagement tapered portion 117, clampingly engages the pin abutment surface 74.

Reverting to FIG. 11A, it is noted that along with the abovementioned abutment between the fastening member 26 and the head coupling pin 60, the fastening engagement portion 112, specifically the fastening peripheral bearing surface 119, also abuts the through bore support surface 108. The pin abutment surface 74 exerts an engagement force G, counter to the fastening force F. The engagement force G is directed normal to the pin abutment surface 74 (i.e., in a radially outwards direction) on the fastening member 26. By virtue of the shallow fastening surface angle α, the engagement force G is advantageously directed towards the through bore support surface 108 which provides a rigid support (as opposed to being directed towards the threaded coupling as shown in U.S. Pat. No. 9,162,295, for example, which can damage the thread(s)). Moreover, the fastening member 26 is effectively wedged between the head coupling pin 60 and a portion of the tool holder 24.

Advantageously, in this fastened position of the rotary cutting tool 20, firm clamping engagement of the cutting head 22 is attained. Such engagement has been found to be particularly effective for interrupted drilling. In addition, the fastening engagement portion prevents axial pull-out of the cutting head 22 from the tool holder 24 when the rotary cutting tool 20 is removed from a workpiece.

Although the subject matter of the present application has been described to a certain degree of particularity, it should be understood that various alterations and modifications could be made without departing from the spirit or scope of the invention as hereinafter claimed.

What is claimed is:

1. A tool holder (24), having a holder longitudinal axis (D), extending in a forward to rearward direction (D_{F}, D_{R}) and about which the tool holder (24) is rotatable in a rotational direction (R), the tool holder (24) comprising:
a holder peripheral surface (78) extending circumferentially about the holder longitudinal axis (D) and forming a boundary of a holder base surface (80) at a forward end of the tool holder (24);
two circumferentially spaced apart driving members (84) extending forwardly from the holder base surface (80);
a holder coupling hole (96) recessed in the holder base surface (80), the holder coupling hole (96) comprising a coupling hole peripheral surface (100) extending circumferentially about the holder longitudinal axis (D); and
a holder through bore (102) comprising a bore peripheral surface (104) extending circumferentially along a holder through bore axis (B) and opening out to the coupling hole peripheral surface (100) to form a through bore inner opening (107A) and the holder peripheral surface (78) to form a through bore outer opening (107B); and
a first holder longitudinal plane (LP1), extending parallel to the holder through bore axis (B) and containing the holder longitudinal axis (D); wherein:
the holder through bore (102) is located entirely on one side of the first holder longitudinal plane (LP1).

2. The tool holder (24), according to claim 1, wherein:
the holder through bore (102) comprises a non-threaded bore engagement portion (106), the through bore inner opening (107A) being formed on the non-threaded bore engagement portion (106);
the bore peripheral surface (104) at the non-threaded bore engagement portion (106) lies on an imaginary bore cylinder (IB) having the holder through bore axis (B) as its axis; and
in a cross-sectional view taken in a holder radial plane (RP) extending perpendicular to the holder longitudinal axis (D) and intersecting the through bore inner opening (107A):
the imaginary bore cylinder (IB) defines parallel inner and outer bore straight lines (LI, LO), the inner bore line (LI) being closer to the first holder longitudinal plane (LP1) than the outer bore line (LO);
both the inner and outer bore lines (LI, LO) are located on the same side of the first holder longitudinal plane (LP1); and
at least the inner bore line (LI) of the inner and outer bore lines (LI, LO) intersects the coupling hole peripheral surface (100).

3. The tool holder (24), according to claim 1, wherein the holder through bore axis (B) does not intersect the holder coupling hole (96).

4. The tool holder (24), according to claim 2, wherein:
only the inner bore line (LI) of the inner and outer bore lines (LI, LO) intersects the coupling hole peripheral surface (100).

5. The tool holder (24), according to claim 2, wherein:
the first holder longitudinal plane (LP1) and a tangent line (T) oriented parallel to the holder through bore axis (B) and tangentially touching the coupling hole peripheral surface (100) are spaced apart by a tangent distance (TD);
the first holder longitudinal plane (LP1) and the inner bore line (LI) are spaced apart by an inner line distance (ID); and
the inner line distance (ID) is greater than 75% of the tangent distance (TD).

6. The tool holder (24), according to claim 2, wherein:
the inner bore line (LI) intersects the coupling hole peripheral surface (100) twice to define first and second intersection points (I1, I2), the first intersection point (I1) being rotationally ahead of the second intersection point (I2);
the first and second intersection points (I1, I2) subtend an intersection angle (β) at the holder longitudinal axis (D); and
the intersection angle (β) fulfils the condition: 45°≤θ≤75°.

7. The tool holder (24), according to claim 6, wherein:
the tool holder (24) has a second holder longitudinal plane (LP2) extending perpendicular to the first holder longitudinal plane (LP1) and containing the holder longitudinal axis (D);
the first and second intersection points (I1, I2) are on opposite sides of the second holder longitudinal plane (LP2).

8. The tool holder (24), according to claim 1, comprising exactly one holder through bore (102).

9. The tool holder (24), according to claim 1, wherein:
the tool holder (24) comprises a holder base abutment surface (82), located on the holder base surface (80); and
the holder base abutment surface (82) is planar and oriented perpendicular to the holder longitudinal axis (D).

10. The tool holder (24), according to claim 1, wherein:
the tool holder (24) comprises two holder flutes (94) recessed in the holder peripheral surface (78) and extending helically about the holder longitudinal axis (D); and
the holder coupling hole (96) opens out to the two holder flutes (94).

11. The tool holder (24), according to claim 1, further comprising:
a fastening member (26) extending along a fastening member axis (C); wherein:
the fastening member (26) comprises a fastening engagement portion (112) and a fastening fixation portion (110) located axially offset from the fastening engagement portion (112).

12. The tool holder (24), according to claim 11, wherein:
the fastening fixation portion (110) comprises a fastening external threaded portion (120);
the fastening engagement portion (112) is non-threaded; and
the non-threaded fastening engagement portion (112) is longer than the fastening external threaded portion (120) in a direction along the fastening member axis (C).

13. The tool holder (24), according to claim 1, wherein:
the holder through bore (102) comprises a bore fixation portion (105), for releasably attaching a fastening member (26) thereto; and
the bore fixation portion (105) comprises a bore internal threaded portion (121).

14. The tool holder (24), according to claim 13, wherein:
the holder through bore (102) comprises a non-threaded bore engagement portion (106), the through bore inner opening (107A) being formed on the non-threaded bore engagement portion (106);
the non-threaded bore engagement portion (106) is located axially opposite the bore internal threaded portion (121);
the non-threaded bore engagement portion (106) comprises a through bore support surface (108) located diametrically opposite the through bore inner opening (107A) about the through bore axis (B).

15. The tool holder (24), according to claim 1, wherein the holder through bore axis (B) lies in the holder radial plane (RP).

16. A rotary cutting tool (20) comprising:
a tool holder (24), in accordance with claim 1; and
a cutting head (22) having a head central axis (A), the cutting head (22) comprising a forward end forming a head cutting portion (28) and a rearward end forming a head coupling portion (30);
the head cutting portion (28) comprising:
a head rear surface (34), defining a boundary between the head cutting portion (28) and the head coupling portion (30);
a head rear abutment surface (38), located on the head rear surface (34);
two cutting arms (42) extending radially with respect to the head central axis (A), each comprising a driven surface (50); and
the head coupling portion (30) comprising a head coupling pin (60), protruding rearwardly from the head rear surface (34) along the head central axis (A), the head coupling pin (60) comprising:
a pin rear surface (62) spaced apart from the head rear surface (34) and a pin peripheral surface (64) extending therebetween;
a pin recess (70), recessed in the pin peripheral surface (64), and comprising a pin recess surface (72) comprising a pin abutment surface (74) which slopes radially outwardly relative to the head central axis (A), in the rearward direction (D_{R}) of the cutting head (22); and
a fastening member (26) releasably engaged to the tool holder (24) at the holder through bore (102); wherein:
the rotary cutting tool (20) is adjustable between a free position and a fastened position, and in the fastened position:
the cutting head (22) is releasably attached to the tool holder (24) by the fastening member (26);
the head coupling pin (60) is located in the holder coupling hole (96);
each cutting arm (42) is in contact with a respective driving member (84); and
the fastening member (26) protrudes into the holder coupling hole (96) and abuts the pin abutment surface (74).

17. The rotary cutting tool (20), according to claim 16, wherein:
the fastening member (26) extends along a fastening member axis (C);
the fastening member (26) comprises a fastening engagement portion (112) and a fastening fixation portion (110) located axially offset from the fastening engagement portion (112);
the fastening fixation portion (110) comprises a fastening external threaded portion (120);
the holder through bore (102) comprises a bore fixation portion (105), for releasably attaching a fastening member (26) thereto;
the bore fixation portion (105) comprises a bore internal threaded portion (121); and
in the fastened position of the rotary cutting tool (20), the fastening external threaded portion (120) is threadingly engaged with the bore internal threaded portion (121).

18. The rotary cutting tool (20), according to claim 17, wherein:
the holder through bore (102) comprises a non-threaded bore engagement portion (106) located axially opposite the bore internal threaded portion (121);
the through bore inner opening (107A) is formed on the non-threaded bore engagement portion (106); and
the non-threaded bore engagement portion (106) comprises a through bore support surface (108) located diametrically opposite the through bore inner opening (107A) about the through bore axis (B); and
in the fastened position of the rotary cutting tool (20):
the fastening engagement portion (112) simultaneously abuts the pin abutment surface (74) and the through bore support surface (108).

19. The rotary cutting tool (20), according to claim 18, wherein:
the fastening engagement portion (112) comprises a fastening engagement end surface (114) and a fastening engagement peripheral surface (116) that extends circumferentially along the fastening member axis (C) and that circumferentially bounds the fastening engagement end surface (114);
the fastening engagement portion (112) comprises a fastening abutment surface (118) and a fastening peripheral bearing surface (119), the fastening peripheral bearing surface (119) being located diametrically opposite the fastening abutment surface (118) about the fastening member axis (C); and
in the fastened position of the rotary cutting tool (20):
the fastening abutment surface (118) abuts the pin abutment surface (74) and the fastening peripheral bearing surface (119) abuts the through bore support surface (108).

20. The rotary cutting tool (20), according to claim 16, wherein:
in the fastened position of the rotary cutting tool (20), the holder radial plane (RP) intersects the pin abutment surface (74); and
in the cross-sectional view taken in the holder radial plane (RP), the pin abutment surface (74) forms an acute fastening surface angle (a) with the through bore axis (B), the fastening surface angle (a) fulfilling the condition: 5°≤α≤15°.

21. The rotary cutting tool (20), according to claim 16, wherein the pin recess surface (72) lies on an imaginary recess cylinder (IC) extending circumferentially along a recess cylinder axis (CA) oriented perpendicular to the head central axis (A), so that the pin abutment surface (74) is concavely curved.

22. The rotary cutting tool (20), according to claim 16, wherein
the tool holder (24) comprises a holder base abutment surface (82) located on the holder base surface (80); and
in the fastened position of the rotary cutting tool (20), the head rear abutment surface (38) abuts the holder base abutment surface (82).

23. The rotary cutting tool (20), according to claim 16, wherein
the head coupling pin (60) comprises exactly one pin recess (70); and
the tool holder (24) comprises exactly one holder through bore (102) and exactly one fastening member (26) releasably engaged to the tool holder (24).

24. The rotary cutting tool (20), according to claim 16, wherein,
in a cross-sectional view taken in a holder radial plane (RP) extending perpendicular to the holder longitudinal axis (D) and intersecting the through bore inner opening (107A);
the bore peripheral surface (104) defines inner and outer bore lines (LI, LO), the inner bore line (LI) being closer to the first holder longitudinal plane (LP1) than the outer bore line (LO); and
both the inner and outer bore lines (LI, LO) are located on the same side of the first holder longitudinal plane (LP1);
the inner bore line (LI) intersects the coupling hole peripheral surface (100) twice to define first and second intersection points (I1, I2), the first intersection point (I1) being rotationally ahead of the second intersection point (I2);
the tool holder (24) has a second holder longitudinal plane (LP2) extending perpendicular to the first holder longitudinal plane (LP1) and containing the holder longitudinal axis (D); and
in the fastened position of the rotary cutting tool (20), the fastening member (26) abuts the pin abutment surface (74) at a contact region located on the same side of the second holder longitudinal plane (LP2) as the first intersection point (I1).

25. The rotary cutting tool (20), according to claim 16, wherein,
the pin peripheral surface (64) has a cylindrical shape having a pin diameter (PD);
the cutting head (22) has an outer cutting diameter (OD); and
the pin diameter (PD) is greater than a third of the outer cutting diameter (OD).

26. A tool holder (24), having a holder longitudinal axis (D), extending in a forward to rearward direction (D_{F}, D_{R}) and about which the tool holder (24) is rotatable in a rotational direction (R), the tool holder (24) comprising:
a holder peripheral surface (78) extending circumferentially about the holder longitudinal axis (D) and forming a boundary of a holder base surface (80) at a forward end of the tool holder (24);
two circumferentially spaced apart driving members (84) extending forwardly from the holder base surface (80);
a holder coupling hole (96) recessed in the holder base surface (80), the holder coupling hole (96) comprising a coupling hole peripheral surface (100) extending circumferentially about the holder longitudinal axis (D); and
a holder through bore (102) comprising a bore peripheral surface (104) extending circumferentially along a holder through bore axis (B) and opening out to the coupling hole peripheral surface (100) to form a through bore inner opening (107A) and the holder peripheral surface (78) to form a through bore outer opening (107B); wherein:
the holder longitudinal axis (D) is not visible from the holder peripheral surface (78) through the holder through bore (102), in a view along the through bore axis (B).
